(19) United States
(12) Patent Application Publication
(10) Pub. No.: US 2025/0187491 A1
(43) Pub. Date: Jun. 12, 2025

(54) APPARATUS AND SYSTEM FOR THE PLACEMENT AND MANAGEMENT OF BATTERY PACKS FOR THE PURPOSE OF POWERING ALL-ELECTRIC COMMERCIAL VEHICLES

(71) Applicant: Jeff Shumway, Sr., Scottsdale, AZ (US)

(72) Inventor: Jeff Shumway, Sr., Scottsdale, AZ (US)

(21) Appl. No.: 18/856,021

(22) PCT Filed: Jun. 30, 2023
(86) PCT No.: PCT/US2023/026731

§ 371 Date: Oct. 10, 2024

Related U.S. Application Data
(60) Provisional application No. 63/358,074, filed on Jul. 1, 2022.

(51) Int. Cl. B60L 58/12; B60K 1/04; B60L 53/80

(52) U.S. Cl. CPC B60L 58/12; B60K 1/04; B60L 53/80; B60K 2001/0444; B60L 2200/28; B60L 2200/36; B60L 2260/52

(57) ABSTRACT

An apparatus and system for mounting, monitoring, and managing one or more battery packs within a housing attached to or, integrated in, a commercial vehicle such as a semi-trailer for the purpose of providing battery power to all-electric powered commercial vehicles. One or more removable battery packs of various sizes may be mounted in one or more housings within an assembly installed on, or included as a structural part of, the frame of a commercial vehicle. Electrical connections on the installed battery packs connect the battery packs to each other and to the commercial vehicle electric motors. Computer systems permit the monitoring and managing of each installed battery pack. Thus, commercial vehicles may be provided with the appropriate battery power supply for an anticipated trip, without being required to purchase or to haul excess batteries and thus excess weight on the trip.

### BACKGROUND

This application claims the benefit of the filing date of U.S. Provisional Patent Application Ser. No. 63/358,074, filed Jul. 1, 2022, for “APPARATUS AND SYSTEM FOR THE PLACEMENT AND MANAGEMENT OF BATTERY PACKS FOR THE PURPOSE OF POWERING ALL-ELECTRIC SEMI-TRAILERS AND OTHER COMMERCIAL TRUCKS,” the complete disclosure of which is hereby incorporated herein in its entirety by this reference.

The present disclosure relates to battery-powered transportation vehicles, and particularly to an apparatus and system for locating batteries on commercial vehicles including, but not limited to, tractor-trailers (i.e. eighteen wheelers), dump trucks, cement mixers, flatbed trucks, tanker trucks, refrigerator trucks, refrigerated trailers, garbage trucks, box vans, cargo vans, freight vehicles, box trucks, trailers, etc. (collectively referred to herein as commercial vehicles), which batteries may be easily and efficiently removed and replaced.

As an example, the long-haul trucking industry relies primarily on a specific type of commercial vehicle that involves tractor-trailer combinations commonly known as semi-trailers or semi-tractor trailers. These semi-trailers typically comprise a tractor (the power unit, sometimes called the cab), and a trailer containing the items being shipped (the load), which trailer the tractor pulls. These semi-trailers presently run, almost exclusively, on diesel fuel.

Running on diesel fuel has several advantages, including the fact that diesel fuel is readily available at nearly any gas station and at truck stops throughout the country. Deisel powered trucks can be rapidly re-fueled. They also typically carry 150 gallons or more of diesel fuel giving them an operating range of 800 miles or more on a single refueling.

Current all-electric semi-trailers and other all-electric commercial vehicles have difficulty addressing the advantages of diesel fuel. That is, where diesel fuel is abundantly available, all-electric commercial vehicles require specialized recharging stations to “refuel.” The necessary recharging stations for battery powered all-electric semi-trailers are currently scarce and installing the number of recharging units required to address this problem will require a substantial capital investment. Where a recharging station is available, recharging a commercial vehicle's electric batteries takes substantially longer than filling a truck with diesel fuel. Also, while a diesel-powered semi-trailer can easily carry enough fuel for long cross-country journeys, currently, the range of an all-electric semi-trailer is limited by the number of batteries built into its tractor. The efficiency of batteries powering all-electric semi-trailers, and thus the range of those vehicles, is affected by environmental conditions and driver habits.

In current use, an all-electric semi-trailer has multiple individual batteries contained within a large battery pack. For example, it is reported that the Tesla “long range” battery pack contains 828 individual 4860 battery cells with each battery pack weighing approximately 1,200 pounds (544.31 kg). It is also reported that to power its semi-tractor with a purported 500-mile (804.67 km) range, Tesla combines up to ten (10) battery packs weighing a combined 12,000 pounds (5443.11 kg). Currently, these multiple battery packs are mounted within the tractor's body as an integral part of the manufacturing. The battery packs are reportedly installed under the floor of the semi-tractor cab approximately between the front axle and the leading rear axle. The maximum number of miles an all-electric tractor-trailer can travel is limited by the size and the number of the battery packs mounted within the tractor.

While the maximum range of an all-electric semi-trailer is limited by the number of battery packs mounted within the tractor, the number of battery packs that can be mounted in a semi-tractor cab is limited by the overall weight restrictions imposed on tractor-trailers. In the United States, Class 8 semi-trailers (eighteen wheelers) are limited to a total gross vehicle weight (“GVW”) of 80,000 pounds (36,287.39 kg), although this weight limit is increased to 82,000 lbs. (37,194.57 kg). for all-electric semi-trailers. This maximum weight restriction includes the tractor, the trailer, the fuel, individuals on board, ancillary tools and equipment, and the load. In other words, everything being moved by the semi-trailer must not exceed the GVW limits. Therefore, the weight of the batteries in the current use effectively reduces the amount of load and other items that can be transported by the all-electric semi-trailer. Put another way, when, in the current use, an all-electric semi-trailer is equipped with more battery capacity then a specific trip requires, the weight of that excess battery capacity necessarily reduces the amount of load that can be carried on the trip.

Another issue facing all-electric semi-trailers is the fact that it is impossible in the current use to customize the amount of battery power carried in the tractor. In contrast to diesel semi-trailers, where the amount of diesel fuel being carried can be easily adapted by simply adding less fuel, thereby saving weight, the number of batteries carried by an all-electric semi-tractor is set at manufacturing. As a result, all-electric semi-tractor manufacturers must manufacture different truck models with varying, but unchangeable, battery sizes to obtain varying ranges. For example, Tesla offers two different versions of its all-electric semi-tractor: one with an estimated 300-mile (563.27 km) range and one with an estimated 500-mile (804.67 km) range. If an owner/operator's typical route requires a 350-mile (563.27 km) range that owner/operator must buy the 500-mile (804.67 km) range model with its larger battery, thus being forced to carry more battery weight than needed and paying for nearly twice the battery capacity required. Alternatively, an all-electric semi-trailer operating with the small battery configuration on a 350-mile (563.27 km) route would be required to stop mid-route to recharge the batteries, thus increasing delivery times and the associated labor costs, and, over time, reducing the maximum number of loads that can be delivered.

While all-electric semi-trailer manufacturers make claims about the mileages their electric semi-trailers will be able to travel, those milage estimates are highly suspect. Electric vehicle milage ranges are highly susceptible to changing environmental conditions and varying driver habits. The current fixed battery manufacturing design with its maximum battery capacity does not permit an owner/operator to adjust for these varying conditions.

For example, in real life testing situations an electric vehicle operating in cold weather conditions of 20° F. (−6.7° C.) loses 10% or more of its actual milage range. If the driver in these cold conditions simultaneously operates the vehicle's interior climate control (heater), the range loss can be as much as 40%. This means that in cold weather an all-electric semi-trailer's estimated 500-mile (804.67 km) range may drop to 300 miles (482.80 km) or less and an all-electric semi-trailer's 350-mile (563.27 km) range may drop to 180 miles (289.68 km) or less. These drops in range, like the weather, are unpredictable, making it unlikely that trucking companies will switch to an all-electric semi-trailer fleet. The risk of having those all-electric vehicles stranded on the road in adverse weather conditions unable to deliver their loads is simply too great. Exacerbating the cold weather range loss is the fact that cold weather can also triple the time required to re-charge the all-electric semi-trailer's batteries.

At the other extreme, operating an all-electric vehicle in extreme heat conditions causes accelerated battery degradation. Charging a battery in high heat conditions may also physically damage the batteries, causing them to operate less efficiently, which may cause a substantial reduction in available battery power, and therefore, range. In other words, both cold and hot weather conditions negatively affect battery performance and can greatly reduce the actual range of the all-electric semi-trailer. Other environmental conditions can also negatively affect all-electric semi-trailer range. For example, head winds can substantially reduce range, as can worn or under-inflated tires, heavier loads, and uphill routes.

In the current use, individual driver habits also can have a large effect on the range of electric semi-trailers. A driver who habitually accelerates hard or drives fast will get substantially fewer miles out of the all-electric semi-trailer's batteries than one who accelerates smoothly or drives slower. It is estimated that driving an electric car at 75 MPH (120.70 KPH) instead of 65 MPH (104.61 KPH) will reduce anticipated range by 15% or more. It can be reasonably anticipated that the range loss of an all-electric semi-trailer may be substantially greater. Put bluntly, a hard pushing driver in adverse weather, with a heavy load on an uphill route, will likely obtain only a small fraction of the manufacturer's milage estimates. These factors make relying on an all-electric semi-trailer to deliver cross county loads a high-risk proposition for the transportation company. These are risks companies are currently unwilling to take.

Furthermore, the current use, which requires that the batteries be an integral part of the semi-tractor body, means that damaged, defective, or depleted batteries cannot be easily repaired or replaced. In the current use, to repair or replace a damaged, defective, or depleted battery requires that the entire all-electric semi-tractor be taken to a repair facility where it will be disassembled to remove and repair or replace the damaged, defective, or depleted battery pack(s). This requires substantial time and effort, resulting in expensive repairs and long down times.

### SUMMARY

According to the present disclosure, battery packs are no longer necessarily installed as an integral part of the manufacture of all-electric commercial vehicles. This disclosure covers an assembly 1) integrated into the structure of the commercial vehicle or a trailer frame; or 2) affixed to the frame of a commercial vehicle or trailer, where that assembly permits the removal and replacement of battery packs. The assembly forms at least one housing, which securely holds one or more battery packs for the purpose of delivering electric battery power to the motors of an all-electric commercial vehicle. Typically, the assembly includes a mounting system, a removable cover, and one or more housings that provide space for securely holding one or more battery packs to the commercial vehicle or trailer. One or more battery packs may be inserted into each of the housings. Multiple assemblies, and therefore multiple housings and battery packs, may be attached to a commercial vehicle or trailer.

According to the present disclosure, the shape and dimensions of the disclosure assembly may be adjusted depending on the requirements of a specific application or the commercial vehicle or trailer to which the assembly is being attached. While this disclosure shows one embodiment wherein the assembly is rectangular, other embodiments may include various sizes of various shapes including, but not limited to, round, oblong, square, hexagon, and other assembly shapes. Similarly, the housing(s) of an assembly may, depending on the requirements of the specific application or the commercial vehicle or the trailer to which the assembly is being attached, be various sizes and shapes to accommodate the secure placement of battery packs of various sizes and shapes.

When held in an assembly, each battery pack is connected to all other battery packs within the assembly and to all other battery packs held in other assembles on the commercial vehicle or trailer through a central electrical wiring harness. This connectivity permits a computer powered integrated power management system to constantly monitor the health and charge of each installed battery pack. The connectivity further permits the delivery of the collective battery power of the battery packs held within the assemblies to the motors of the commercial vehicle via a coupler or other connection devise that allows connection to the commercial vehicle's wiring harness and then to its electric motors. When held in an assembly each battery pack is connected to all other battery packs within the assembly and to all other battery packs held in other assembles on the commercial vehicle or trailer through a dedicated electrical wiring harness permitting the battery packs held within the assemblies to be recharged via a coupler or other connection devise that allows connection to an external recharging devise. Each individual battery pack within an assembly may also be quickly removed and replaced. When removed from the assembly, the battery packs are stored in a dedicated assembly/housing rack, where they may be monitored, maintained, and recharged. While held in an assembly, whether attached to a commercial vehicle or held in a dedicated assembly/housing rack, the battery packs may be cooled or heated as required to improve their performance.

Because each battery pack can be removed individually, damaged, defective or depleted battery packs can be replaced quickly and easily without the necessity of moving the commercial vehicle to a repair facility and dissembling the commercial vehicle. This will permit battery packs to be removed and replaced anywhere a replacement battery pack is available.

Attaching varying numbers of assemblies to, for example, a semi-trailer, allows an owner/operator to calculate, by use of the power management system or by other means, the number of battery packs required for a trip and to carry only the required number of battery packs, thus reducing battery weight and increasing load weight. The ability to easily carry multiple combinations of battery packs allows all-electric semi-trailer manufacturers to build their tractors with a minimal battery range, thus reducing manufacture weight and cost, while allowing an owner or operator to only purchase and carry as many battery packs as required for their particular use. Such advantageous flexibility is accomplished by simply adding or removing battery packs from the assemblies. Hence, an owner or operator need only invest in (and carry the weight of) the approximate number of battery packs required for the distance, weight, and demands of their loads. And, by storing replacement batteries strategically along a route, an owner or operator can ensure that there will be fully charged battery packs available to address any unexpected route conditions or battery failures, thus taking most, if not all, of the risk out of operating an all-electric commercial vehicle.

### BRIEF DESCRIPTION OF THE DRAWINGS

Other features and advantages of the present disclosure will be apparent from reference to the following Descriptions taken in conjunction with the accompanying Drawings, in which:

FIG. 1 depicts a side view of a representative current all-electric semi tractor;

FIG. 2 depicts a perspective view of a representative battery pack;

FIG. 3 depicts a side view of a representative current all-electric semi tractor and indicates approximately where the battery pack(s) is located on the semi-tractor;

FIG. 4 depicts a perspective side view of a representative 53′ (16.15 m) trailer used in conjunction with a semi-trailer;

FIG. 5 depicts a top-down plan view of a representative 53′ (16.15 m) trailer frame showing representative structural end members, structural side members, a central main structural member extending to each end member and equidistant between the side structural members, and perpendicular structural cross-members extending from each side of the central main structural member to the structural side members;

FIG. 6 shows a head-on view of an exemplary assembly with a top, floor, two sides, a back, an open front (covered during operation), and an internal divider forming two housings for securely holding battery packs, with the two side structures extended upwards for attaching the assembly to the trailer frame from below;

FIG. 7 depicts a side view of a representative 53′ (16.15 m) trailer frame with panels on the ends and sides forming walls, a roof, and a floor attached atop of the frame forming an enclosed box accessible by doors inserted in the rear and/or on the sides of the box and further showing the voids created between the frame's perpendicular structural frame members;

FIG. 8 depicts an exemplary assembly as described in FIG. 6 shown positioned below a portion of the trailer frame, where the trailer floor sits atop the trailer frame and the frame's perpendicular cross-members and where the extended sides of the assembly are designed to attach to the frame's perpendicular cross-members of the trailer;

FIG. 9 depicts a front view of an exemplary assembly forming two housings and showing how the assembly may be mounted to the frame's perpendicular cross-members via bolts through the frame's perpendicular cross-members and the extended sides of the assembly, and further showing a vibration dampening product between the assembly's extended sides and the frame's perpendicular cross-members;

FIG. 10 shows an expanded view of the extended side of the assembly being attached via a bolt through the side of the assembly, a vibration dampening product, and the frame's perpendicular cross-member;

FIG. 11 depicts a side view of a representative trailer with three assemblies attached to the bottom of the trailer frame's perpendicular cross-members where each assembly forms two housings for holding battery packs and a depiction of an exemplary placement of a box containing the power management system;

FIG. 12 depicts a front view of the assembly forming two housing cavities for holding at least one battery pack and showing an exemplary location of one possible iteration of internal mounts for securely holding at least one battery pack in the housing, with an expanded front view of an exemplary internal housing mount where a male connector for securely attaching a battery pack would be inserted into a female aperture within the housing;

FIG. 13 depicts a side view example of one embodiment of the internal housing mount of FIG. 12 showing a front threaded female receptable and a rear male bolt for securing a battery pack within the housing;

FIG. 14 depicts a side view of an exemplary trailer having two assemblies installed adjacent to one another under the frame of the trailer, each assembly having two housings for carrying battery packs and where each assembly does not extend below the lowest point of the retracted front trailer stand and a depiction of an exemplary placement of the box containing the power management system;

FIG. 15 depicts a rear view of two battery packs that would be held in the assembly where each battery pack has 1) an electrical connection for attaching the battery pack to a central wiring harness and 2) an additional electrical connection for attaching the battery pack to a wiring harness dedicated to the recharging of the battery packs;

FIG. 16 depicts a top-down plan view of a trailer frame according to one embodiment of the present invention, showing electrical wiring from connectors on the battery packs connecting with a main wiring harness that connects to a coupler or other connection at the front of the trailer for connecting the battery packs held in assemblies on the trailer to the electric motors on the tractor and to the box containing the power management system;

FIG. 17 depicts a top-down plan view of a trailer frame showing one embodiment of electrical wiring from connectors attached to the battery packs connecting to a wiring harness for recharging the battery packs. The wiring harness connects to a coupler or other connector at the rear of the trailer for connecting the assemblies and the battery packs held in the assemblies to an external recharging device, and also depicts an exemplary placement of the box containing the power management system according to one embodiment of the invention;

FIG. 18 depicts an exemplary trailer with a coupler or other connector on the front of the trailer for connecting the trailer battery power to the semi-tractor motors and a coupler or other connector at the rear of the trailer for connecting the battery packs held in the trailer to an external charging source, and also depicts an exemplary placement of the box containing the power management system according to another embodiment of the invention;

FIG. 19 depicts a side view of an exemplary height adjustable trolly for attaching to a battery pack and inserting the battery pack in, or removing it from, an assembly according to one embodiment of the present invention;

FIG. 20 depicts a front view of a battery pack rack with assemblies forming housing cavities for storing, monitoring, and recharging multiple battery packs while those battery packs are not installed in an assembly according to one embodiment of the present invention;

FIG. 21 depicts a top-down plan view of a representative trailer frame showing the exemplary installation of multiple assemblies below the trailer floor and between the trailer frame's perpendicular cross-members, and also depicts an exemplary placement of the box containing the power management system according to yet another embodiment of the present invention;

FIG. 22 depicts a side view of the trailer of FIG. 21 with assemblies installed below the trailer floor and between the frame's perpendicular cross-members and a depiction of an exemplary placement of the box containing the power management system according to one embodiment of the present disclosure; and

FIG. 23 depicts a front view of one embodiment of an assembly and a removable, protective cover that can be locked in place to protect the battery packs installed in assemblies on an all-electric commercial vehicle or trailer from the elements.

### DETAILED DESCRIPTION

Hereinafter, embodiments of the present disclosure will be described in detail with reference to the accompanying drawings. Embodiments of the present disclosure are provided to more completely explain the present disclosure to those of ordinary skill in the art. The following embodiments may be modified or changed in various other forms. The scope of the present disclosure is not limited to the following embodiments. These embodiments are provided so that this disclosure will be clearer and more thorough, and these embodiments are provided to convey the spirit of the present disclosure to those skilled in the art.

The size of details in the accompanying drawings may be exaggerated and/or out of their proper relationship to other details for convenience and clarity. In the drawings, like reference numerals refer to like elements. The term “and/or” as used herein includes any one and all combinations of one or more of those referenced items. The term “connected” used herein means not only when, for example, member A and member B are directly connected, but also when member A and member B are indirectly connected by interposing member C between member A and member B.

The terminology used herein describes representative embodiments and is not intended to limit the present disclosure. As used herein, the singular form may include the plural. Where used, the term “comprise, include” and/or “comprising, including” specifies the presence of the referenced shapes, numbers, steps, actions, members, elements, and/or groups thereof but does not preclude the presence or addition of one or more other shapes, numbers, steps, actions, members, elements and/or groups.

It is apparent that the terms “first,” “second,” etc. are used herein to describe various members, parts, regions, layers and/or portions, but these members, parts, regions, layers, and/or portions are not limited by these terms. These terms are used only to distinguish one member, component, region, layer or portion from another member, component, region, layer or portion. Accordingly, a first member, component, region, layer, or portion described below may refer to a second member, component, region, layer or portion without departing from the teachings of the present disclosure. Space-related terms such as “beneath”, “below”, “lower”, “above”, and “upper” may be used for easy understanding of one element or feature that is different from one element or feature shown in the drawings or to show the relationship between one or more elements or features shown in the drawings to other elements of features shown in the drawings. These space-related terms are for ease of understanding of the present disclosure according to various process conditions or usage conditions of the present disclosure and are not intended to limit the present disclosure.

Further, the power management system and other related devices or components according to the present disclosure may be implemented using any suitable hardware, firmware (e.g., application-specific semiconductors), software, app, wireless devise, or a suitable combination of software, app, wireless devise, firmware and/or hardware. For example, various components of a power management system and other related devices or components according to the present disclosure may be formed on one integrated circuit chip or on separate integrated circuit chips or may be housed remotely and connected to the components of the present disclosure over a wireless connection. Various components of the power management system may be implemented on a flexible printed circuit film, or may be formed on a tape carrier package, a printed circuit board, or the same substrate as the power management system. Various components of the power management system may be processes or threads executing in one or more processors in one or more computing devices, and it may execute computer program instructions and interact with other components to perform various functions mentioned herein. The computer program instructions are stored in a memory that can be executed in a computing device using a standard memory device such as a random-access memory or may be accessed on a storage devise located remotely and accessed via wireless connection. The computer program instructions may also be stored in other non-transitory computer readable media, such as a CD-ROM, flash drive, or the like. It should be appreciated by those skilled in the art related to the present disclosure that the functions of various computing devices are, or may be, combined with each other or integrated into one computing device, or the functions of a particular computing device may be distributed in one or more other computing devices without departing from an exemplary embodiment of the present disclosure.

It will be appreciated by those skilled in the art that according to the present disclosure, the shape and dimensions of the disclosure assembly may be adjusted depending on the requirements of a specific application or the commercial vehicle or trailer to which the assembly is being attached. While this disclosure shows one embodiment wherein the assembly is rectangular, other embodiments may include various sizes of various shapes including, but not limited to, round, oblong, square, hexagon, and other assembly shapes. Similarly, the housing(s) formed within an assembly may, depending on the requirements of the specific application or the commercial vehicle or trailer to which the assembly is being attached, be various sizes and shapes to accommodate the secure placement of battery packs of various sizes and shapes.

It will be appreciated by those skilled in the art that varying the size and shape of assemblies the housings formed therein can be adapted to securely hold battery packs from a variety of manufacturers.

It will be appreciated by those skilled in the art that for any commercial vehicle or trailer a plurality of assemblies and housings may be employed enabling a plurality of battery packs to be carried on the commercial vehicle or trailer.

It will be appreciated by those skilled in the art there where a plurality of battery packs is carried on a commercial vehicle or trailer within one or more assemblies, each of those battery packs may be removed and replaced individually without removing any other battery pack contained in the same or another assembly.

It will be appreciated by those skilled in the art that a box containing a power management system may be placed in other positions on a trailer, or may be placed on a semi-tractor or other commercial vehicle, or may be portioned between a location on a trailer and a semi-tractor or commercial vehicles. In those applications where the assembly is attached to a commercial vehicle not pulling a trailer the power management system may be place within the assembly, attached to the assembly, attached elsewhere on the commercial vehicle or portioned between one or more locations within an assembly, attached to an assembly or elsewhere on the commercial vehicle.

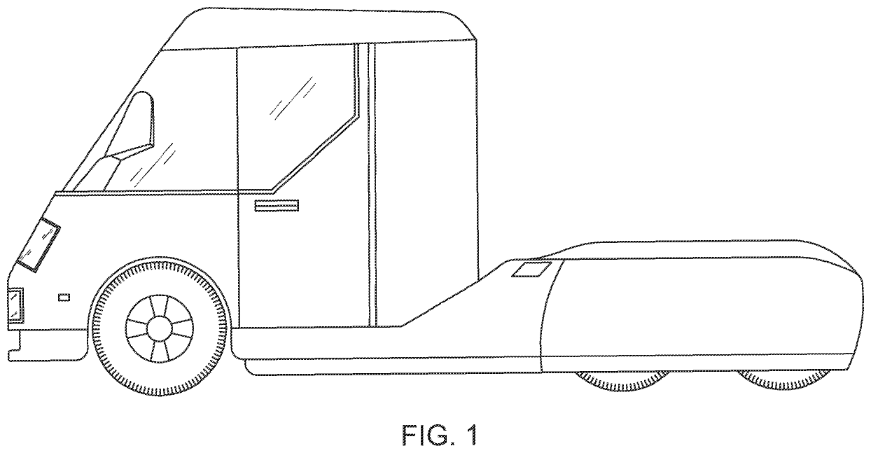

FIG. 1 is a representative drawing showing a design for an all-electric semi-tractor. Current all-electric semi-tractors are typically configured at manufacturing with a set battery pack that determines the maximum mileage range of that vehicle.

Electric semi-tractors such as the one depicted in FIG. 1 typically have the batteries installed within the tractor as part of the manufacturing process where the batteries typically reside under the floor of the driver's compartment between the front axle and the rear axle.

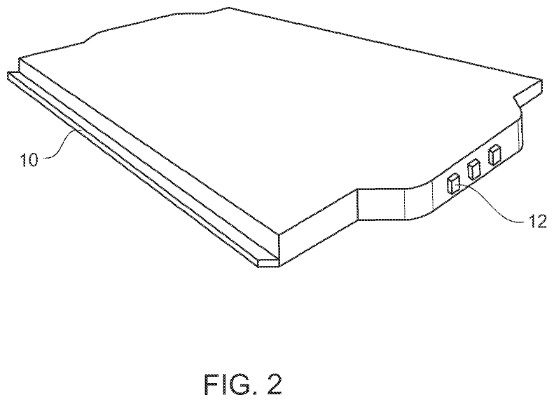

FIG. 2 depicts a representative battery pack 10 for the current embodiment according to the present disclosure. The battery pack 10 contains multiple (200 or more) individual batteries combined and held in a single enclosed, sealed housing. Each battery pack has connectors 12 that are required to connect the battery energy to the electric motors of the vehicle, a recharging station, and the power management system. Current all-electric commercial vehicles typically configure multiple battery packs 10 within the semi-tractor for the purpose of providing power to the motors.

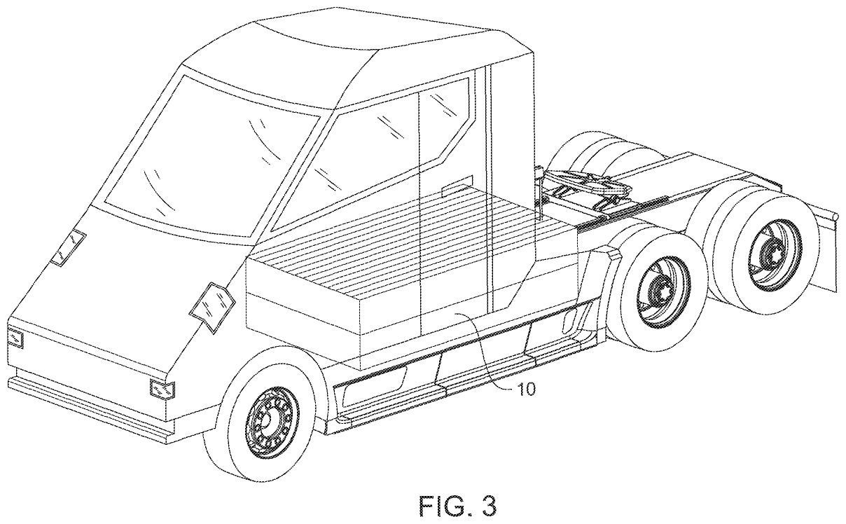

FIG. 3 shows a representative all-electric semi-tractor with multiple battery packs 10 installed under the floor of the driver's compartment between the front axle and the leading rear axle.

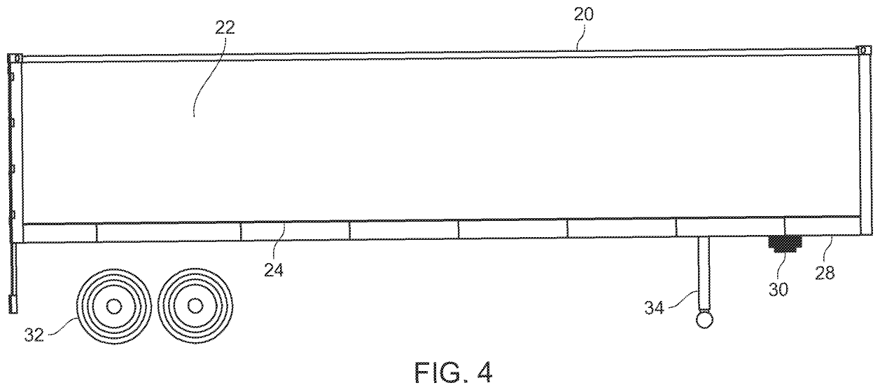

As depicted in FIG. 4, a typical semi-trailer 20 has a box 22 with a floor 24 built upon a frame 28 with a coupler 30 for connecting to a semi-tractor with wheels 32 for transport and with a stand 34 for holding the end of the trailer when it is not connected to a tractor.

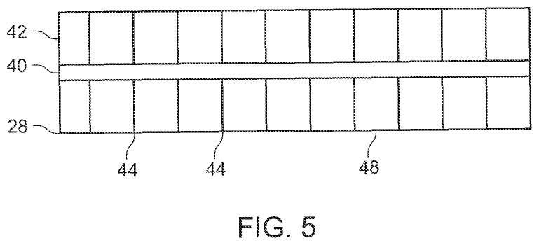

As depicted in FIG. 5, according to one embodiment of the present disclosure, the representative trailer frame 28 has a central frame member 40 connected to end piece frame members 42, with multiple supporting frame members 44 attached perpendicular to the central frame central member 40 and extending and attaching to frame rail structures 48 on both sides of the trailer frame 28 that, with the end piece frame members 42, form the frame of the trailer 28.

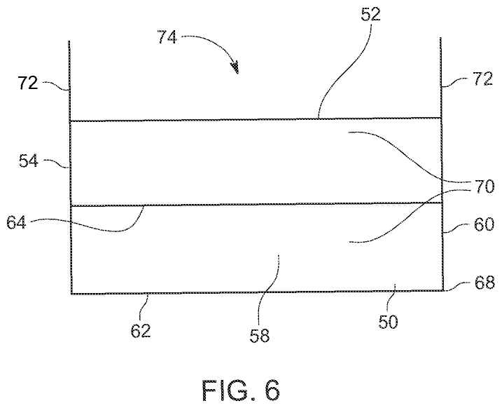

As depicted in FIG. 6, according to one embodiment of the present disclosure, an assembly 50 when viewed from the front, includes a top 52, sides 54, an open, accessible front 58, which is covered during operation, and a back 60, a floor 62, and one or more internal dividers 64, the totality of which form a frame 68 with cavities (hereafter “housings”) 70, each of which will securely hold one or more battery packs 10. The sides 54 of the assembly 50 extend beyond the top of the housing 52 to create brackets 72 whereby the assembly can be attached to the perpendicular frame members 44 to hold the assembly securely under the trailer frame 28. When the assembly is installed on the trailer in this embodiment of the present disclosure, the top 52 of the assembly 50 (which, in this embodiment also forms the top of one housing 70) creates a void 74 between the top 52 of the assembly 50, the trailer's perpendicular frame members 44, and the floor of the trailer 24. This void 74 creates a sealed (that is, a water-tight or weather-proof) space suitable for holding electrical wiring, monitoring devices, and components from the battery packs 10 installed in the housings 70.

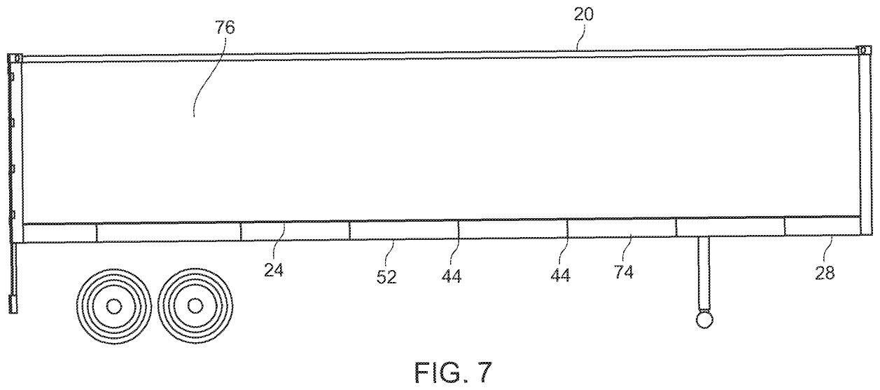

FIG. 7 depicts a trailer 20 as seen from the side with a trailer skin 76 removed from over the perpendicular frame members 44, thereby revealing the ends of the perpendicular frame members 44. As depicted in FIG. 7, the trailer floor 24 and the perpendicular frame members 44 form a void 74 where the top of the assembly 50 forms the bottom of the void 74.

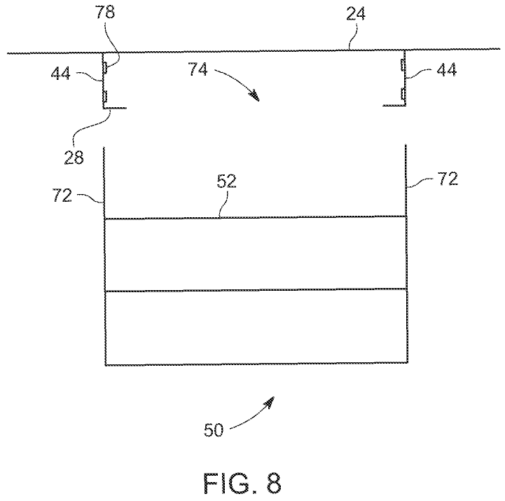

As depicted in FIG. 8, according to one embodiment of the present disclosure, the assembly 50 is mounted or “hung” to the bottom of the trailer frame 28 by attaching the assembly 50 via bolts or other mechanisms through the extended side brackets 72 and the perpendicular cross-members 44 of the frame so that the assembly 50 sits below the bottom of the trailer frame 28 creating a void 74 between the trailer floor 24, the perpendicular cross members 44, and the top of the Assembly 52.

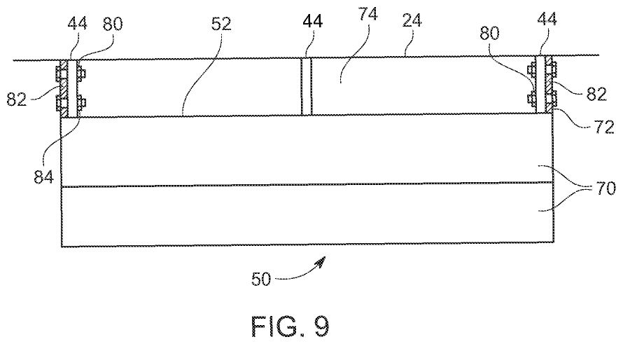

As depicted in FIG. 9, according to one embodiment of the present disclosure, an assembly 50 forming two housings 70 is attached to the bottom of the trailer's perpendicular frame members 44 through the assembly's extended side brackets 72 and a vibration damping material 82 by bolts 80 secured by a self-locking washer and nut 84, thereby creating a void or cavity 74 between the top of the housing 52 and the bottom of the trailer floor 24.

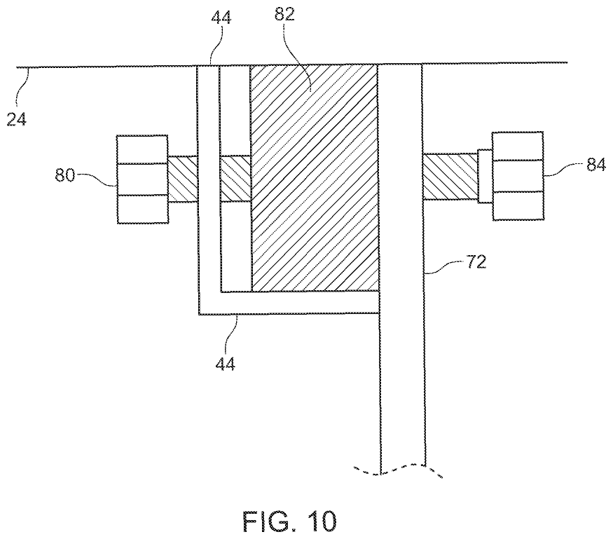

As depicted in FIG. 10, according to the one embodiment of the present disclosure, the threaded bolt 80 is inserted through the perpendicular trailer frame member 44, through a vibration dampening material 82, through the assembly extended side bracket 72, and then secured with a self-locking washer and nut 84. Typically, a plurality of threaded bolts is used to mount the assembly 50 under a perpendicular frame member 44 of the semi-trailer 20. A plurality of assemblies 50 may be mounted under a plurality of perpendicular frame members 44 permitting a plurality of battery packs to be secured in a plurality of housings 70,

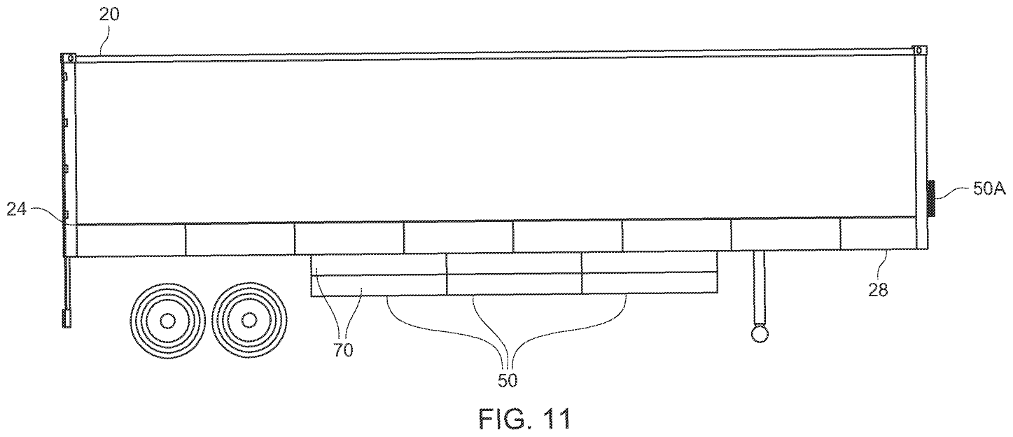

As depicted in FIG. 11, according to the one embodiment of the present disclosure, the exemplary trailer 20 has three assemblies 50 each containing two housings 70 mounted below the trailer frame 28 with each housing 70 able to hold at least one battery pack 10. Also shown is a box 50A for containing the power management system.

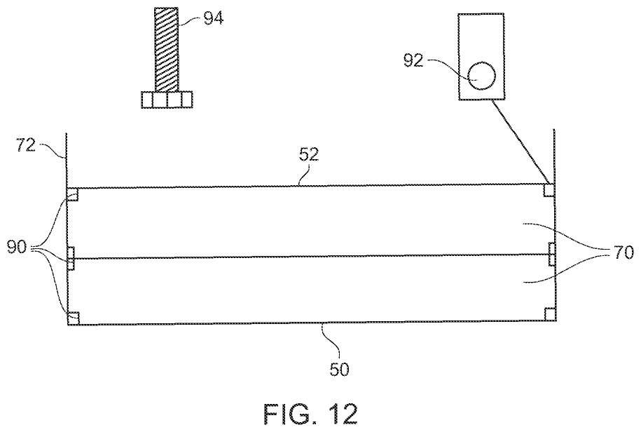

As depicted in FIG. 12, according to one embodiment of the present disclosure, each housing 70 in the assembly 50 contains internal mounts 90 that allow each battery pack 10 to be securely held in place within the housing 70. Each of these mounts 90 may, for example, contain a threaded female receptacle 92 into which a bolt 94 through the battery pack 10 is inserted and tightened until the battery pack 10 is securely fastened.

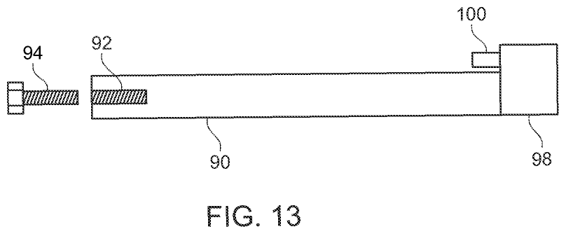

As depicted in FIG. 13, according to the one embodiment of the present disclosure, the back 98 of the exemplar internal mounts 90 have a male pin or bolt 100 and the battery pack 10 has a female receptable that is pushed over the pin or bolt 100 until the battery pack 10 is secure. The front of the internal bracket 90 has a threaded female receptacle 92 where the battery pack 10 is installed flush to the internal bracket 90 and a threaded bolt 94 is inserted until the battery pack 10 is secure in the housing 70.

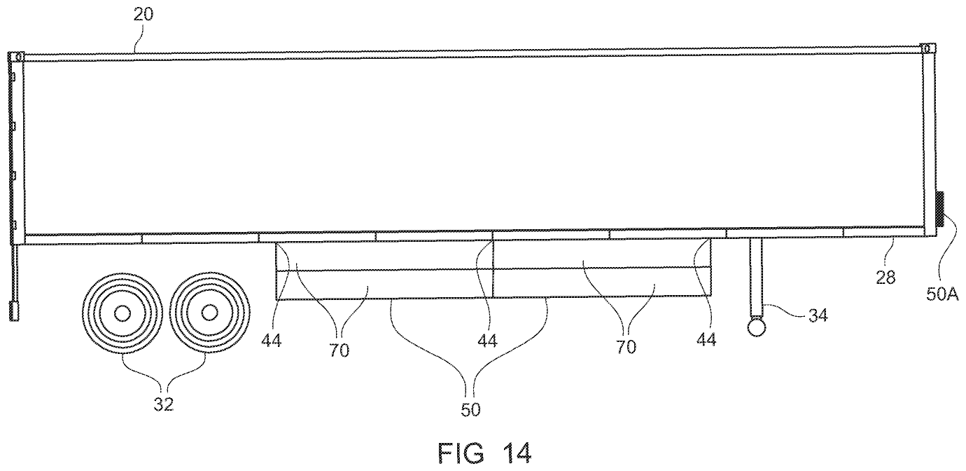

As depicted in FIG. 14, according to one embodiment, when installed under a trailer 20, the assembly 50 is attached to the bottom of the frame perpendicular cross members 44 between the wheels 32 of the trailer 20 and the trailer's front stand 34. The assembly or assemblies 50 typically do not extend farther below the frame of the trailer 28 than the bottom of the trailer's retracted front stand 34. In this embodiment each assembly 50 forms two housings 70, each of which will hold a battery pack 10. Also shown is the box 50A for containing the power management system.

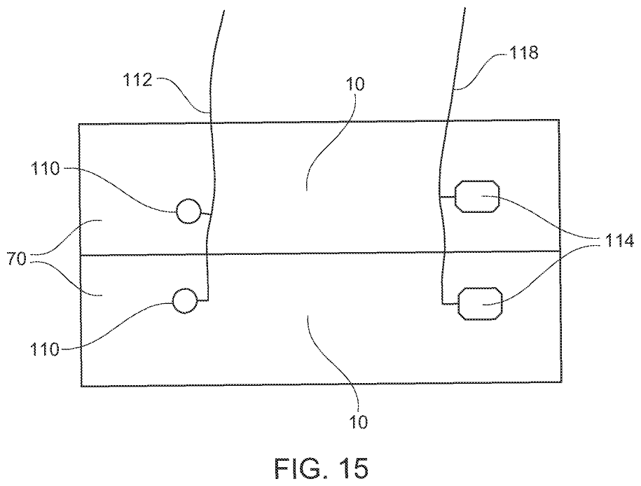

FIG. 15 depicts the rear of two battery packs 10 that are held in an assembly 50, each within a housing 70. Each battery pack 10 has an electrical connection 110 for connecting to an electrical wiring 112 harness, thereby enabling the connection of the battery pack 10 to an external recharging device, and separate electrical connectors 114 for connecting an electrical wiring harness 118 to a main electrical writing harness for delivering battery energy to the motors of the all-electric semi-tractor FIG. 1. Each of these respective connections 110, 114 may be connected to the wiring connections from other battery packs 10 held in other housings 70 within other assemblies 50 mounted on the trailer 20. In this manner all battery packs 10 may be simultaneously recharged and the energy from all battery packs 10 will be simultaneously available to the motors of the semi-tractor FIG. 1. Alternatively, battery management software contained in the box 50A may be used and, in conjunction with trip planning, one or more specific battery packs 10 may be discharged faster or slower than others, thereby allowing for possible efficiency gains by figuratively removing a spent battery pack 10 from the system or when replacing a spent battery pack 10 with a freshly charged battery pack 10.

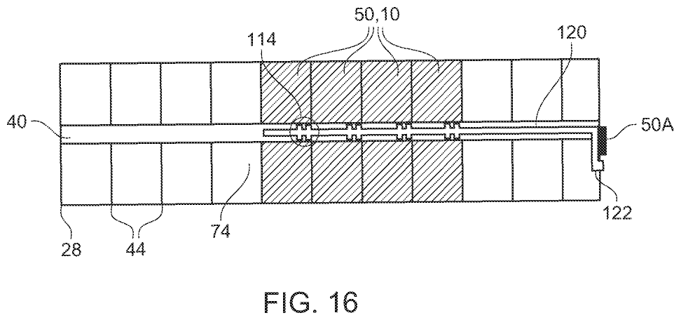

As depicted in FIG. 16, according to one embodiment of the present disclosure, viewing a trailer frame 28 from the top down, each assembly 50 is attached to the bottom of the perpendicular frame members 44 creating a void 74 above the assembly 50 and between the perpendicular frame members 44. Battery packs 10 housed in an assembly 50 are connected to a main wiring harness 120 via connectors 114 in the back of the battery packs 10. Typically, all battery packs 10 are connected to a main wiring harness 120 which in this example is held within the trailer's central frame member 40. The main wiring harness 120 connects to a coupler or other type of connector 122 at the front of the trailer 20 and to the box 50A on the front of the trailer 20 containing the power management system. The coupler provides a connection from the trailer's main wiring harness 120 to the semi-tractor wiring harness, thereby providing power from all the trailer's 20 battery packs 10 to the semi-tractor's motors.

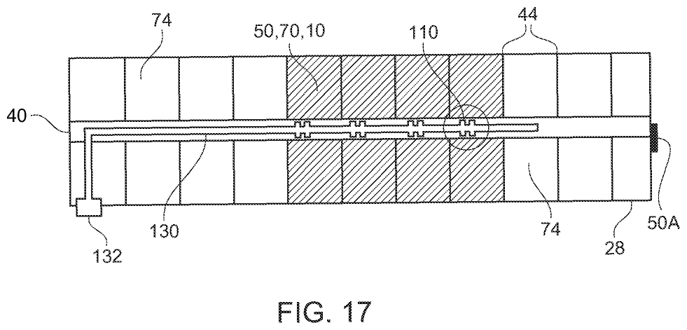

FIG. 17 depicts a top view of a trailer frame with the box 50A containing the power management system in a different location, according to one embodiment of the present disclosure. As depicted, each assembly 50 is attached to the bottom of the perpendicular frame members 44 creating a void 74 above the assembly 50 and between the perpendicular frame members 44. Battery packs 10 held in housings 70 in each assembly 50 are connected to a main recharging wiring harness 130 via connectors 110 in the back of each battery pack 10. Typically, all battery packs 10 electrically join at the recharging wiring harness 130 held in this example within the central frame member 40. The recharging wiring harness 130 connects to a coupler or other connector 132 at the rear of the trailer 20. The coupler provides a connection from the trailer recharging wiring harness 130 to an external recharging unit. This allows all battery packs 10 held within all assemblies 50 to be simultaneously recharged, for example, when the trailer is being loaded or unloaded, or when the trailer is standing idle.

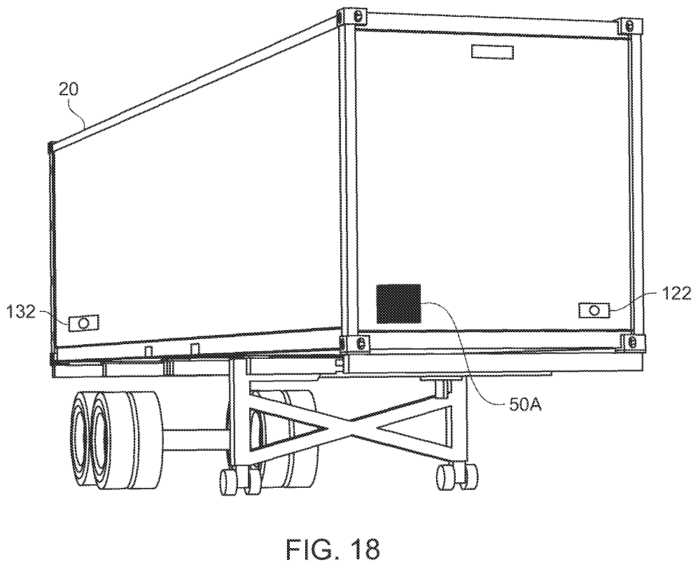

As depicted in FIG. 18, a typical trailer 20 will have an electrical wiring connection connecting to the main wiring harness such as the coupler 122, located in a different position in this example, and the box 50A at the front of the trailer to connect the trailer's 20 main wiring harness 122 battery power to the semi-tractor and to the power management system, and a recharging wiring harness coupler 132 at the rear of the trailer 20 to connect the main recharging harness 130 to the battery packs 10 held in assemblies 50 and housings 70.

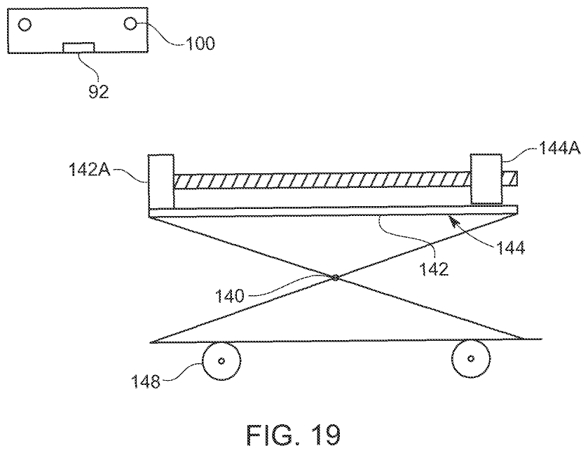

FIG. 19 depicts a representative height adjustable dolly 140 on wheels 148 with a tabletop 142, a task specific screw drive 144, a devise for advancing and retreating the screw drive 142A, and a moveable devise 144A for connecting to the battery pack's 10 internal mounts 100, 92 according to one embodiment of the present disclosure. Once connected, the battery pack 10 can be securely inserted or removed from the assembly 50. The dolly 140 with screw drive 144 makes inserting or removing battery packs simple, fast, and secure.

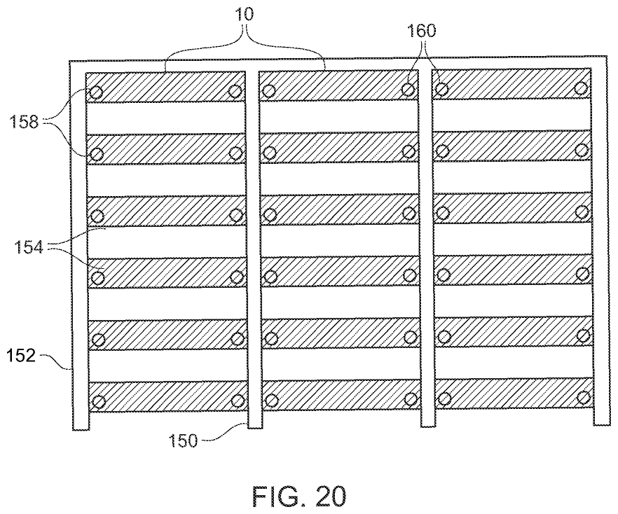

As depicted in FIG. 20, according to one embodiment of the present disclosure a representative battery pack rack 150 comprises a frame 152 for holding the assembly 50 in multiple cavities 154 in which battery packs 10 can be secured through female receptacles 158 and stored while not held in the assembly 50 on a trailer 20. While in the rack, each battery pack 10 can be monitored, recharged, and maintained via wiring couplers or connectors 160 attached to each battery pack 10.

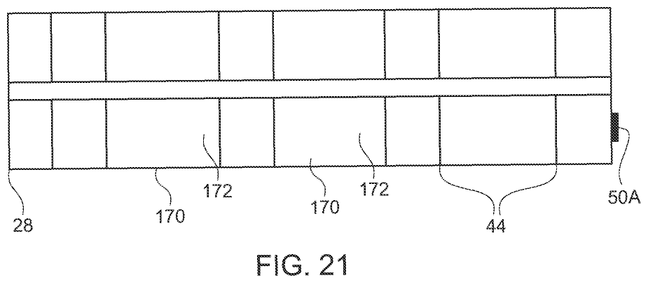

FIG. 21 depicts a trailer frame 28 viewed from the top down according to one embodiment of the present disclosure. In original trailer manufacturing, battery packs may be incorporated into the structure of the trailer, for example by removing certain perpendicular frame members 44 creating larger distances 170, 172 between perpendicular frame members 44 and integrating assemblies 50 into the frame 28 within these new spaces 170, 172. As a result, the assemblies 50 and inserted battery packs 10 are placed beneath the trailer floor 24, but typically as part of the structure of the frame, and not below, the frame 28.

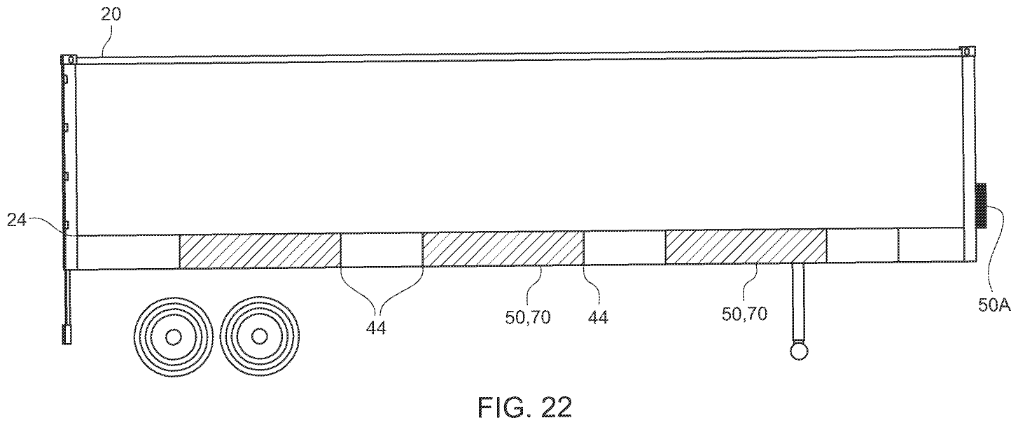

As depicted in FIG. 22, according to one embodiment of the present disclosure, in original manufacturing, the assembly 50 is installed as an integral part of the trailer 20 frame 28 structure with battery pack(s) 10 installed in the housing 70 and held below the trailer floor 24 while providing structural strength to the trailer frame 28 and thus become an integral part of the trailer's frame 28.

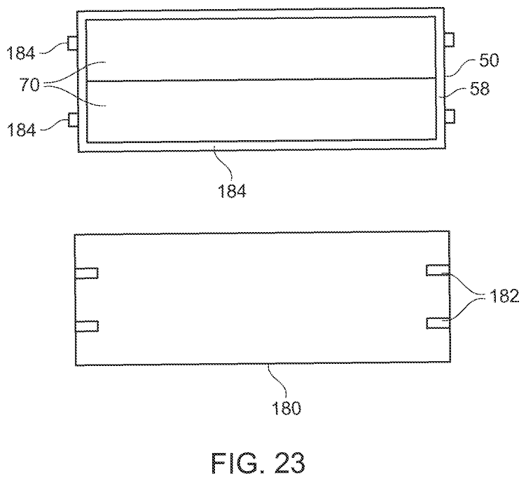

As depicted in FIG. 23, according to one embodiment of the present disclosure, each assembly 50, with its housings 70 (whether installed as part of the structure of the frame as shown in FIG. 22 or installed below the frame as shown in FIG. 11) is covered by a removable tight-fitting cover 180 that can be installed on the exposed front 58 of the assembly 50. The cover in this embodiment 180 is fitted with locks 182 that hold the cover 180 securely to the assembly 50, thereby protecting the assembly 50, housings 70, and the installed battery packs 10 from the elements. The interior side of the cover 180 and the assembly 50 may have a fabricated channel 184 that fits securely over the assembly 50. The cover 180 is held securely in place by a locking mechanism on the cover 182 that attaches to a locking mechanism on the assembly 50 and over the fabricated channel 184 for securely locking the cover in place.

As described above, currently diesel semi-trailers enjoy significant advantages over electric semi-trailers. The present disclosure addresses these advantages and makes it possible for electric semi-trailers to not only compete effectively with diesel trucks, but in many instances to outperform them. Because of the characteristics of electric motors, electric vehicles have greater torque, increased acceleration and power, and greater towing capacity. The present disclosure provides a realistic design for taking advantage of these facts, while overcoming the inherent deficiencies of electric vehicles.

First, by way of example, moving the batteries to the trailer substantially increases the maximum amount of battery power that can be carried, thus increasing potential milage ranges. Second, under the designs of the current disclosure, it is a relatively simple matter to add or subtract batteries housed in assemblies on an exemplary trailer, thereby making it possible for a single semi-trailer design to be used for a wide variety of milage and load requirements and in varying environmental conditions. This means that a manufacturer does not need to make multiple versions of their electric commercial vehicles with varying battery capacities. Rather, one vehicle can handle a large variety of possible mileage and load requirements simply by adding or subtracting battery power on the trailer (or in the cab, if the cab is provided with multiple assemblies for holding battery packs). For the same reason, proper battery management helps adjust for various extremes in the weather. On extremely cold or hot days, an owner or operator can simply insert additional battery packs into the housing, thereby increasing the range. Each assembly can also be adapted to permit battery packs installed in the housings to be heated or cooled as may be required to offset weather caused inefficiencies. Importantly, an owner or operator will be able to monitor the health and charge of each battery pack and make adjustments or replacements to ensure the safe completion of the trip.

Third, by making the batteries accessible and easily removed and replaced, damaged, defective, or depleted batteries no longer require expensive and time intensive repairs. Rather, damaged, defective, or depleted battery packs can be replaced simply and quickly by removing the old battery pack and replacing it with a fully functioning replacement battery pack. Fourth, being able to increase the truck's range simply by adding battery packs via the housings should reduce the problems resulting from a lack of recharging stations. All-electric semi-trailers constructed according to the present disclosure will typically be able to travel eight hundred miles or more, reducing the number of recharging stops required on a cross-country trip and, as a result, reducing the number of required charging stations. Furthermore, depleted batteries may be simply and quickly replaced with fully recharged batteries eliminating much of the down time wasted waiting to recharge those batteries. Downtimes which often include sitting in line waiting to get access to an appropriate charger.

A significant advantage of the present disclosure is that fully charged, undamaged battery packs can be stored at convenient locations throughout the country making it possible for long haul truckers who have reached their maximum available range to stop and have their battery stores quickly replenished. For example, locations such as the current truck stops located along interstate highways could stock battery packs on site in racks that permit the battery packs to be monitored, recharged, and maintained ensuring that undamaged, fully charged battery packs are available at all times to replace damaged or depleted battery packs being carried on a semi-trailer. When a semi-trailer with damaged or depleted battery packs arrives at a truck stop, it typically will be a relatively simple matter to remove the damaged or depleted battery pack(s) and install undamaged, fully charged replacement battery packs into the assembly. The turnaround time for replacing battery packs is anticipated to be a matter of minutes and substantially shorter than the time required to fully recharge the battery packs on the semi-trailer.

The potential to store battery packs at locations across the country may lead to an entire battery pack leasing/rental business whereby companies purchase large quantities of battery packs and hold them in racks until they are needed to replace depleted or damaged battery packs on semi-trailers. Once needed, the battery packs will be swapped out with the leasing company handling the logistics of tracking the battery packs, billing for swapping out battery packs and for the use of the replacement battery packs. These battery pack leasing companies could effectively “front” the capital costs of purchasing battery packs and be responsible for the maintenance and charging of their stock of battery packs. By bearing the capital cost of purchasing battery packs, battery pack leasing companies may be able to significantly reduce the up-front costs of purchasing an all-electric tractor-trailer or other commercial vehicle by buying and leasing battery packs to commercial vehicle purchasers. A co-op of transportation companies could potentially work together to provide similar services.

Racks holding battery packs while they are not installed in a trailer can serve a secondary purpose. For those facilities that have not yet made use of solar power because of the costs, the battery pack racks can serve as external power storage of the power generated by the solar installation replacing current battery storage units. Connecting the battery packs within the racks to a solar power generator serves multiple purposes including using solar power to recharge and maintain the charge of battery packs held in the racks. At the same time, the cumulated stored energy is available to power the facilities when the sun is down or covered by clouds, thus making it possible to operate a 24-hour truck stop solely on solar power.

Alternatively, in those situations where a truck driver intends to make an extended stop at a truck stop facility (for example where the driver intends to eat, sleep, shower, or relax), the batteries held within the assembly may be recharged by being connected to a direct current rapid charger (“DCRC”). The use of DCRC stations (or similar charging stations) in such situations will incentivize truck stop operators to invest in installing charging stations. These networks of DCRC may also provide recharging for the general, electric vehicle driving public to recharge their vehicles. These DCRC networks may be owned by the truck stops or owned by third party companies that install the chargers and charge for their use. Recharging stations located at truck stops or other convenient locations can be set up for both on site billing (i.e., credit and debit cards) or direct customer billing (i.e., billing a trucker's company directly and automatically for the recharge).

Battery packs, whether installed in an assembly on a commercial vehicle or being held in a recharging rack, may be monitored at all times. This constant monitoring will enable the commercial vehicle owner or operator to always know the state of charge of the battery pack and to monitor the efficiency and health of the battery pack. This monitoring will allow owners or operators to receive early notification when a possible problem arises and take action, such as stopping and swapping out that battery pack, before the problem becomes critical. This monitoring may include battery efficiency, battery temperature, charge levels, discharging rates, etc., and may thereby permit early identification of a defective battery.

The apparatus of the present disclosure will also allow devices to be added to the trailers for the purpose of recharging the battery packs during semi-trailer operation. For example, wind driven fans powering small turbines could be added to the trailers providing an ongoing charge to the battery packs. Similarly, solar panels on the roof of the trailer could provide charging for the battery packs during daylight hours. Recharging via vehicle braking systems is also a possibility. Each of these possible on-the-road recharging methods has the potential of further extending the milage range of commercial vehicles.

Battery packs held in the housing may be cooled or heated in place, as required to ensure optimal operation. While this cooling and heating is a drain on battery power, the ability to carry excess battery power should permit cooling and heating without reducing the effective milage range of the commercial vehicle. Similarly, the current system and apparatus will permit shippers to ship their goods in a temperature-controlled environment because the additional battery power required to power a refrigerated trailer can be simply and quickly added to the trailer.

In current use, transportation companies operating as full-load carriers, such as Swift Transportation, typically own and operate two to three times the number of trailers as semi-tractors. Therefore, a company that owns one thousand semi-tractors may also own three thousand trailers. The useful life of these trailers is significantly longer than the useful life of the semi-tractors. Owning more trailers than semi-tractors allows a company to park trailers at a customer's dock for loading and unloading while not having to leave a semi-tractor on site. Because there are many more trailers than tractors to pull them, it is important that the trailers be interchangeable. The present disclosure permits the current fleet of trailers to be retrofitted to carry the assemblies and, therefore, battery packs. Retrofitting the current fleet of trailers will be feasible because the present disclosure mounts the assembly to the semi-trailer, a process that can be completed on virtually any trailer. By retrofitting existing trailers, transportation companies will avoid the substantial additional capital cost of buying new trailers for their electric fleet, thus making adoption of fully electric semi-trailers less capital intensive and, therefore, much faster.

As with battery packs, it is likely that a substantial number of new and retrofitted trailers may be owned by leasing companies that will lease the trailers to the trucking companies. These leasing companies will handle the logistics of tracking the trailers, maintaining the trailers, and billing for their use. The use of leasing companies will reduce the initial capital costs of transitioning to an electric fleet thereby making the transition quicker. Currently there are several trailer leasing companies active in the market. These companies are likely to expand their business into the electric vehicle market.

Local laws in certain jurisdictions allow semi-trailers that are composed of two, and sometimes three, trailers to be towed behind a single semi-tractor. These trailer configurations, where permitted, allow a semi-trailer to carry additional weight above the standard 80,000 lbs. (36,287.39 kg) Gross Vehicle Weight. These additional trailers will sometimes permit the hauling of loads in excess of 100,000 lbs. (45,359.24 kg) GVW. While the typical single trailer is 53′ (16.15 m) in length, trailer lengths vary greatly from 24′ (7.32 m) to 53′ (16.15 m). In situations where multiple trailers may be towed behind a tractor, each trailer can have its own set of assemblies and battery packs held in the assemblies' housings. In these situations, the battery packs from each trailer may be connected to the battery packs on other trailers being towed so that the combined battery power of all trailers is available to power the semi-tractor's motors. These additional trailer combinations would also enjoy the other benefits of holding battery packs in assemblies on the trailers.

Many large companies receive semi-trailer deliveries virtually daily. For example, large box retail stores have goods delivered from central distribution centers to their warehouses on a nightly basis. For these types of customers, it may be advantageous to have recharging stations at their locations so that trailers that have been dropped for loading or unloading can have their battery packs recharged while parked. This available recharging will permit the owner or operator of the commercial vehicle to minimize the number of battery packs required for vehicles delivering goods to particular stores on a nightly basis, a significant advantage over the operator who purchases a semi-tractor with a fixed battery component.

It will be appreciated by those skilled in the art that various battery pack installation designs and configurations exist that meet the functionality requirements of the various commercial vehicle configurations used in the industry. Although particular embodiments of the present invention as related to the long-haul semi-trailer industry have been described, those of skill in the art will appreciate that various modifications and changes may be made by those skilled in the art without departing from the spirit and scope of the invention. The present invention may be embodied in other specific forms without departing from its structures, methods, or other essential characteristics as broadly described herein and claimed hereinafter. The described embodiments are to be considered in all respects only as illustrative, and not restrictive.

1. A trailer to be used in conjunction with an all-electric commercial vehicle for transportation of goods, the commercial vehicle having at least one electric motor for propelling the vehicle, the motor being connected to a wiring harness, the trailer comprising:
a frame having a central frame member, side frame members, end frame members, and a plurality of structural struts extending between the side frame members and the central frame member and between the end frame members to provide structural frame support for the trailer;
an assembly affixed to the trailer, the assembly having a top, a bottom, a first side, a second side, and a back, the top, bottom, sides and back forming at least one housing in which a battery pack may be removably mounted;
a cover for the assembly to protect the battery pack when mounted in the assembly; and
a battery pack having an electrical connection for connecting the mounted battery pack to the wiring harness to provide electrical power from the battery pack to the at least one motor through the wiring harness.

2. The trailer of claim 1 wherein the electrical connection and the wiring harness permit communication between the mounted battery pack and any other battery packs mounted on the trailer.

3. The trailer of claim 1 wherein the electrical connection permits recharging of the battery pack.

4. The trailer of claim 1 wherein the electrical connection and the wiring harness permit communication between the battery pack and a power management system that monitors at least one of:
battery pack energy capacity;
battery pack charge status:
battery pack approximate range;
battery pack recharging requirements;
battery pack efficiency;
overall estimated range of the mounted battery packs; and
overall estimated charge status of the mounted battery packs.

5. The trailer of claim 1 wherein the electrical connection and the wiring harness permit communication between the battery pack and the power management system that manages at least one of:
battery pack available energy capacity;
battery pack available charge status;
battery pack available approximate range;
battery pack recharging;
battery pack efficiency;
overall estimated available estimated range of the mounted battery packs;
overall estimated available charge status of the mounted battery packs;
overall estimated available approximate range of the mounted battery packs;
overall estimated recharging of the mounted battery packs;
overall efficiency of the mounted battery packs; and
driver inputs to the at least one motor of the commercial vehicles.

6. The trailer of claim 1 wherein the power management system uses information collected about the battery pack to determine projected range of the battery pack mounted in the housing when the battery pack is powering the at least one motor in propelling the vehicle.

7. An assembly connected to an electric commercial vehicle used for transportation of goods, the commercial vehicle designed to be propelled by at least one electric motor, the assembly comprising:
a top, a bottom, two first sides, and a back that collectively forming a housing in which a battery pack may be removably mounted; and
an electrical connection on the assembly for connecting to the battery pack to the motor when the battery pack is mounted in the assembly.

8. The assembly of claim 7 further comprising a wiring harness for electrically connecting the mounted battery pack to the at least one motor.

9. The assembly of claim 7 further comprising a cover for the assembly to protect the battery pack when mounted in the assemble.

10. An assembly joined to an electric commercial vehicle, the assembly comprising electric receptables for facilitating communication between motors of the commercial vehicle and removeable battery packs that may be mounted in the assembly.

11. A system for providing a commercial vehicle with a supply of electrical power for at least one electric motor on the commercial vehicle, the system comprising:
a plurality of assemblies into which a plurality of battery packs may be mounted, each assembly including at least one connection for electrical wiring for providing electrical communication between the mounted battery packs and the at least one motor;
a power management system for monitoring at least one of the following characteristics of the battery packs mounted in the at least one assembly:
battery pack energy capacity;
battery pack charge status:
battery pack approximate range;
battery pack recharging requirements;
battery pack efficiency;
overall estimated range of the mounted battery packs; and
overall estimated charge status of the mounted battery packs;
the power management system for also managing at least one of the following characteristics of the battery packs mounted in the at least one assembly:
battery pack available energy capacity;
battery pack available charge status;
battery pack available approximate range;
battery pack recharging;
battery pack efficiency;
overall estimated available range of the at least one mounted battery packs;
overall estimated available charge status of the at least one mounted battery packs;
overall estimated available approximate range of the mounted battery packs;
overall estimated recharging of the mounted battery packs;
overall efficiency of the mounted battery packs; and
driver inputs to the at least one motor of the commercial vehicles;
calculating a minimum number of battery packs necessary to provide sufficient power to the at least one motor to permit the commercial vehicle to complete a predetermined trip along a predetermined route with the commercial vehicle carrying a predetermined load by considering at least one of:
approximate charge held by each of the available battery packs;
age and condition of each of the available battery packs;
projected distance of the predetermined trip;
weight of the load to be transported on the trip;
elevation gain and loss involved in the predetermined trip;
approximate temperatures along the route of the predetermined trip;
weather condition projections along the route of the predetermined trip;
planned stops along the predetermined route of the predetermined trip;
recharging devices available along the predetermined route of the predetermined trip;
information regarding the availability of replacement battery packs along the predetermined route of the predetermined trip; and
projected driver inputs during the predetermined trip; and
mounting the calculated minimum number of battery packs on the assemblies prior to the predetermined trip.

12. A storage system for holding a plurality of battery packs, the battery packs having internal mounts and electrical connections formed thereon, the system comprising:
a storage rack having a plurality of cavities formed by top, bottom, side, and intermediate frame members, each cavity designed to contain a battery pack of a predetermined size, each cavity further comprising an electrical interface for monitoring and recharging a battery pack through the electrical connections on the battery packs; and
a mobile dolly comprising a tabletop and a task specific screw drive, the screw drive designed to attach the dolly to internal mounts on a battery pack allowing the battery pack to be inserted or removed from the storage rack and to secure the battery pack to the dolly for transporting the battery pack to and from the storage rack.
